(19) United States
(12) Patent Application Publication
(10) Pub. No.: US 2014/0181143 A1
(43) Pub. Date: Jun. 26, 2014

(54) FILE PRESENTATION METHOD AND APPARATUS

(71) Applicant: Huawei Technologies Co., Ltd., Shenzhen (CN)

(72) Inventors: Hai Chang, Shenzhen (CN); Zhiyou Guo, Hangzhou (CN); Rui Li, Nanjing (CN)

(73) Assignee: Huawei Technologies Co., Ltd., Shenzhen (CN)

(21) Appl. No.: 14/136,248

(22) Filed: Dec. 20, 2013

Related U.S. Application Data
(63) Continuation of application No. PCT/CN2013/080648, filed on Aug. 1, 2013.

(30) Foreign Application Priority Data
Dec. 26, 2012 (CN) 201210576216.3

(51) Int. Cl. G06F 17/30

(52) U.S. Cl. CPC G06F 17/30106
USPC 707/772

(57) ABSTRACT

Embodiments of the present invention provide a file presentation method and apparatus, and relate to the field of data management, which can help a user manage and view data. The file presentation method includes: obtaining files and file information typed by a user and corresponding to the files; extracting keywords from the file information corresponding to the files and using the keywords as tags of the files; and presenting files with a same tag according to a preset rule. The present invention can be applied in data management and viewing.

### CROSS-REFERENCE TO RELATED APPLICATIONS

This application is a continuation of international application no. PCT/CN2013/080648, filed on Aug. 1, 2013, which claims priority to Chinese patent application no. 201210576216.3, filed on Dec. 26,2012, all of which are hereby incorporated by reference in their entireties.

### TECHNICAL FIELD

The present invention relates to the field of data management, and in particular, to a file presentation method and apparatus.

### BACKGROUND

In a current storage technology, data is classified and stored according to storage time, data size, data format, and the like. With the popularity of intelligent devices, people can record and store data quickly at any time by using such devices as a mobile phone, a tablet computer, a camera, and the like. Using a smart phone as an example, a user uses the phone to record one idea and take photos for the moment, and the phone stores newly generated data in a storage module. When browsing the data at a later time, the user may view the data by storage time, file size, and file format, and the like.

However, this viewing manner is fixed and inflexible, and cannot establish an organic association of user activities between data and data, thereby causing poor user experience in viewing data.

### SUMMARY

The present invention provides a file presentation method and apparatus, which can help a user manage and view data.

According to a first aspect, the file presentation method includes:
obtaining files and file information typed by a user and corresponding to the files; extracting keywords from the file information corresponding to the files, and using the keywords as tags of the files; and presenting files with a same tag according to a preset rule.

In a first possible implementation manner of the first aspect, the obtaining files and file information typed by a user and corresponding to the files includes: receiving, by cloud, a data packet from a same user of one or more terminals, where the data packet includes the files and the file information typed by the user and corresponding to the files; the extracting keywords from the file information corresponding to the files and using the keywords as tags of the files includes: extracting, by cloud, the keywords from the file information corresponding to the files, and using the keywords as the tags of the files; and the presenting files with a same tag according to a preset rule includes: presenting, by cloud, the files with a same tag according to the preset rule.

In a second possible implementation manner of the first aspect, the obtaining files and file information typed by a user and corresponding to the files includes: generating, by a terminal, the files and the file information typed by the user and corresponding to the files; the extracting keywords from the file information corresponding to the files and using the keywords as tags of the files includes: extracting, by the terminal, the keywords from the file information corresponding to the files, and using the keywords as the tags of the files; and the presenting files with a same tag according to a preset rule includes: presenting, by the terminal, the files with a same tag according to the preset rule.

With reference to the first aspect of the present invention and the first and second possible implementation manners of the first aspect, in a third possible implementation manner of the present invention, the file information corresponding to the files is voice information; the extracting keywords from the file information corresponding to the files and using the keywords as tags of the files includes: extracting keywords of the voice information by using a speech recognition technology, and setting the keywords as tags of data.

With reference to the first aspect of the present invention and the first and second possible implementation manners of the first aspect, in a fourth possible implementation manner of the present invention, the file information corresponding to the files is text information; the extracting keywords from the file information corresponding to the files and using the keywords as tags of the files includes: extracting keywords of the text information by using a text recognition technology, and setting the keywords as tags of data.

With reference to the first aspect of the present invention and the first, the second, the third, and the fourth possible implementation manners of the first aspect, in a fifth possible implementation manner of the present invention, the presenting files with a same tag according to a preset rule includes: presenting the files with a same tag according to a sequence of time at which the files are obtained.

With reference to the first aspect of the present invention and the first, the second, the third, and the fourth possible implementation manners of the first aspect, in a sixth possible implementation manner of the present invention, the presenting files with a same tag according to a preset rule includes: presenting the files with a same tag in an aggregate form.

In a sixth implementation manner of the first aspect of the present invention, in a seventh implementation manner of the present invention, after the presenting files with a same tag according to a sequence of time at which the files are obtained, the method further includes: receiving an association operation performed by the user on at least two files with different tags, so that the at least two files receive a new common tag; receiving a tag input by the user, and using the tag as the new common tag of the at least two files after the association operation.

With reference to the seventh implementation manner of the first aspect, in an eighth implementation manner of the present invention, after the receiving a tag input by the user and using the tag as the new common tag of the at least two files after the association operation, the method further includes: according to the new common tag of the files with different tags, presenting the files with different tags and with the new common tag according to a sequence of time at which the files with different tags are obtained; or, according to the new common tag of the files with different tags, presenting the files with different tags and with the new common tag in an aggregate form.

According to a second aspect, the file presentation apparatus includes:
an obtaining unit, configured to obtain files and file information typed by a user and corresponding to the files; an extracting unit, configured to extract keywords from the file information corresponding to the files, and use the keywords as tags of the files; and a presenting unit, configured to present files with a same tag according to a preset rule.

In a first possible implementation manner of the second aspect, the file presentation apparatus is a cloud apparatus; the obtaining unit is specifically configured to receive a data packet from a same user of one or more terminals, where the data packet includes the files and the file information typed by the user and corresponding to the files; the extracting unit is specifically configured to extract the keywords from the file information corresponding to the files, and use the keywords as the tags of the files; and the presenting unit is specifically configured to present the files with a same tag according to the preset rule.

In a second possible implementation manner of the second aspect, the file presentation apparatus is a terminal apparatus; the obtaining unit is specifically configured to generate the files and the file information typed by the user and corresponding to the files; the extracting unit is specifically configured to enable the terminal to extract the keywords from the file information corresponding to the files and use the keywords as the tags of the files; and the presenting unit is specifically configured to present the files with a same tag according to the preset rule.

With reference to the second aspect and the first and the second possible implementation manners of the second aspect, in a third possible implementation manner of the present invention, the file information corresponding to the files is voice information; the extracting unit is specifically configured to extract, by using a speech recognition technology, keywords of the voice information, and set the keywords as tags of data.

With reference to the second aspect and the first and the second possible implementation manners of the second aspect, in a fourth possible implementation manner of the present invention, the file information corresponding to the files is text information; the extracting unit is specifically configured to extract, by using a text recognition technology, keywords of the text information, and set the keyword as tags of data.

With reference to the second aspect and the first, the second, the third, and the fourth possible implementation manners of the second aspect, in a fifth possible implementation manner of the present invention, the presenting unit is specifically configured to present the files with a same tag according to a sequence of time at which the files are obtained.

With reference to the second aspect and the first, the second, the third, and the fourth possible implementation manners of the second aspect, in a sixth possible implementation manner of the present invention, the presenting unit is specifically configured to present the files with a same tag in an aggregate form.

With reference to the fifth possible implementation manner of the second aspect, in a seventh possible implementation manner of the present invention, the apparatus further includes a receiving unit, where after the presenting unit presents the files with a same tag according to the sequence of time at which the files are obtained, the receiving unit is configured to receive an association operation performed by the user on at least two files with different tags, so that the at least two files receive a new common tag, receive a tag input by the user, and use the tag as the new common tag of the at least two files after the association operation.

With reference to the seventh implementation manner of the second aspect, in an eighth implementation manner of the present invention, after the receiving unit receives the tag input by the user and uses the tag as the new common tag of the at least two files after the association operation, the presenting unit is further configured to: according to the new common tag of the files with different tags, present the files with different tags and with the new common tag according to a sequence of time at which the files with different tags are obtained; or, the presenting unit is further configured to: according to the new common tag of the files with different tags, present the files with different tags and with the new common tag in an aggregate form.

In the file presentation method and apparatus provided by the embodiments of the present invention, tags of files are extracted from file information corresponding to the files, and the files are presented according to the tags, which helps a user perform classified management and viewing on the files according to the tags, thereby greatly improving user experience in managing and viewing data.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of a file presentation method according to an embodiment of the present invention;

FIG. 2 is a schematic diagram illustrating the storing of data by using a cloud storage technology according to an embodiment of the present invention;

FIG. 3 is a flowchart of storing data by using a cloud storage technology according to an embodiment of the present invention;

FIG. 4 is a flowchart of a file presentation method according to another embodiment of the present invention;

FIG. 5 is a flowchart of a file presentation method according to another embodiment of the present invention;

FIG. 6A to FIG. 6C are schematic diagrams of file presentation manners according to an embodiment of the present invention;

FIG. 7 is a block diagram of a file presentation apparatus according to an embodiment of the present invention;

FIG. 8 is a block diagram of a file presentation apparatus according to another embodiment of the present invention;

FIG. 9 is a block diagram of a computer system according to an embodiment of the present invention; and

FIG. 10 is a block diagram of a computer system according to another embodiment of the present invention.

### DETAILED DESCRIPTION

The following clearly describes the technical solutions in the embodiments of the present invention with reference to the accompanying drawings in the embodiments of the present invention. Apparently, the described embodiments are merely apart rather than all of the embodiments of the present invention. All other embodiments obtained by a person of ordinary skill in the art based on the embodiments of the present invention without creative efforts shall fall within the protection scope of the present invention.

A file presentation method and apparatus provided by embodiments of the present invention are hereinafter described in detail with reference to accompanying drawings.

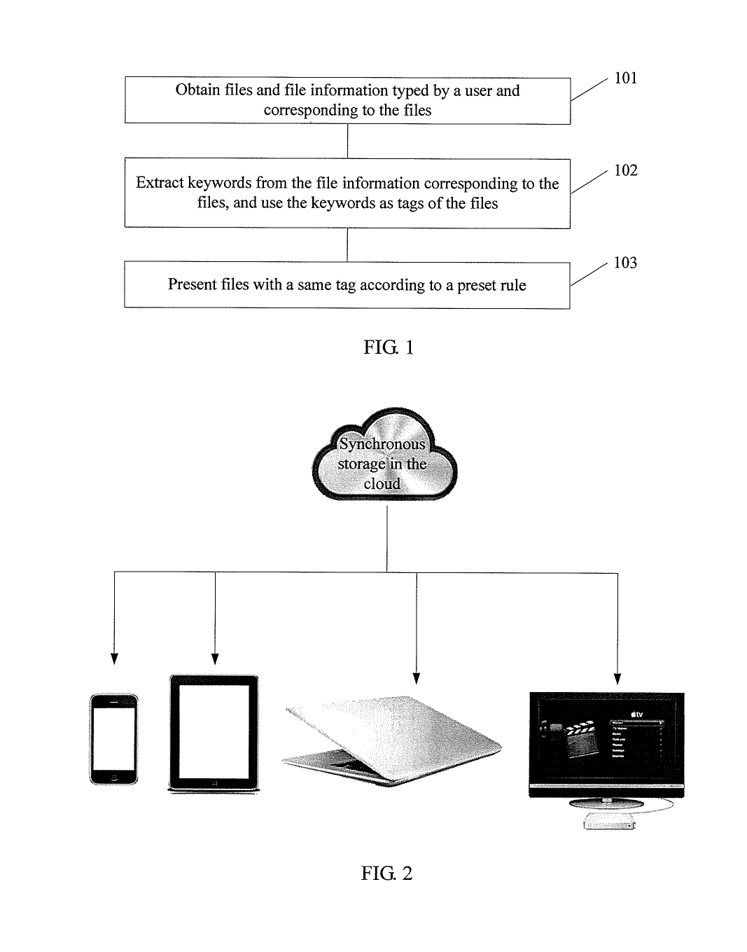

An embodiment of the present invention provides a file presentation method. As shown in FIG. 1, the method includes the following steps:

101. Obtain files and file information typed by a user and corresponding to the files.

In this step, the obtained files may be a photo taken by the user, a document, a picture, an audio, a log, a video, and the like. The file information corresponding to the files refers to information corresponding to the files in terms of content or other aspects, including information such as feeling, place, and task recorded by the user and related to files. The information may be represented in many forms, for example, a voice form or a text form.

102. Extract keywords from the file information corresponding to the files, and use the keywords as tags of the files.

The tag may be related to a data file in terms of content or other aspects, which may be one or more and represent the file to a certain degree. When there are multiple tags, the tags may be classified into a primary tag and a secondary tag according to a degree of association between the tags and data content of the file. The manner of extracting a tag may use multiple patterns, for example, if time information corresponding to a file is document data, one or more words that most frequently occur in the file may be set as the tag of the file, that is, a keyword in the file information is used as the tag of the file. In another example, if time information corresponding to a file is recording data, a keyword that most frequently occurs in the file may also be set as the tag of the file.

103. Present files with a same tag according to a preset rule.

In this step, if multiple different files have a same tag, it indicates that the file data is mutually associated in terms of content or other aspects, files with the same tag may be presented together and files with different tags may be presented in a differentiated manner.

In the file presentation method provided by the embodiment of the present invention, tags of files are extracted from file information corresponding to the files, and the files are presented according to the tags, which helps a user perform classified management and viewing on the files according to the tags, thereby greatly improving user experience in managing and viewing data.

In another embodiment provided by the present invention, step 101 may be specifically as follows:

A cloud receives a data packet from a same user of one or more terminals, where the data packet includes files and file information typed by a user and corresponding to the files.

The element “cloud” is also referred to as cloud storage. It is a system that uses such functions as cluster application, grid technology or distributed file system to integrate a large quantity of various storage devices by using application software to work collaboratively and provide data storage and service access functions externally.

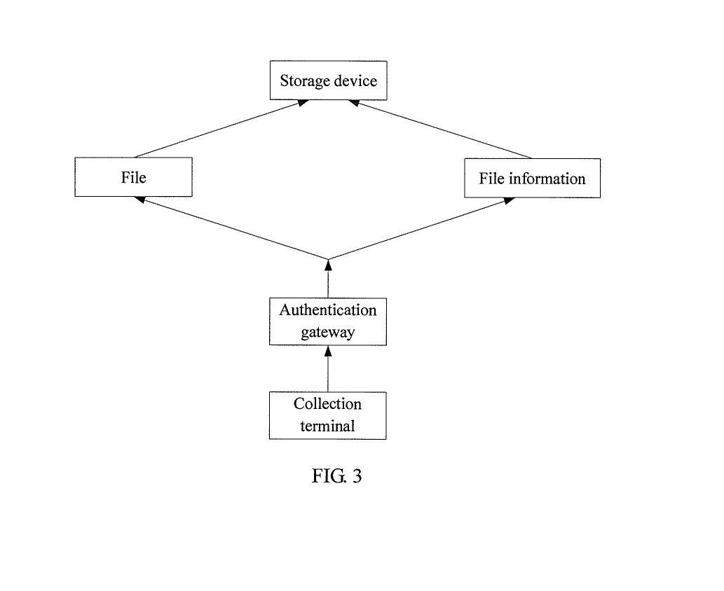

In this step, as shown in FIG. 2, the cloud may receive a data packet from a same user of such fixed or mobile terminal devices as a mobile phone, a computer, a tablet computer, and a notebook computer, where the data packet includes the file information typed by the user and corresponding to the files. All the foregoing obtained data is uniformly stored in a cloud storage area to facilitate unified management on the data of the user. In addition, the same user may be identified by using an authentication gateway such as a same user name or a same login email box. In a block diagram illustrated in FIG. 3, the present invention can provide a user with an account and a password (that is, the authentication gateway) to help the same user to log in to the cloud, so that all data packets sent by one or more terminals are uniformly sent to the cloud storage area.

The cloud storage area cuts and marks the storage area according to a time scale to facilitate the storage of the files obtained in step 101 and the file information typed by the user and corresponding to the files and data obtained according to the time. The user can manage (for example, name, classify, delete, establish a relationship, and the like) the data on the time scale.

Accordingly, step 102 may be specifically as follows:

The cloud extracts keywords from the file information corresponding to the files, and uses the keywords as tags of the files.

Step 103 may be specifically as follows:

The cloud presents the files with a same tag according to a preset rule.

In the file presentation method provided by the embodiment of the present invention, the cloud receives a data packet from a same user of one or more terminals, which helps a user perform unified management on data and addresses disadvantages of decentralized collection and decentralized management of data.

In another embodiment provided by the present invention, step 101 may be specifically as follows:

A terminal generates files and file information typed by a user and corresponding to the files.

Accordingly, step 102 may be specifically as follows:

The terminal extracts keywords from the file information corresponding to the files, and uses the keywords as tags of the files.

Step 103 may be specifically as follows: The terminal presents files with a same tag according to a preset rule.

In the file presentation method provided by the embodiment of the present invention, a terminal generates files and file information typed by a user and corresponding to the files, extracts tags of the files from the file information corresponding to the files, and presents the files according to the tags, which helps the user perform classified management and viewing on the files by tag on any terminal, thereby greatly improving user experience in managing and viewing data.

In still another embodiment provided by the present invention, in step 101, file information corresponding to files is voice information.

Accordingly, step 102 may be specifically as follows:

Extract keywords of the voice information by using a speech recognition technology, and set the keywords as tags of data.

The voice information may correspond to a file in terms of content or other aspects. The voice information related to the file may be obtained before or after the file is obtained or concurrently when the data is obtained. For example, when a user is traveling in Paris, the user takes photos by using a mobile phone, and records his/her current feeling by using voice information “I am traveling in Paris now. How beautiful the scenery is!” The voice information corresponds to the content of the photo data, records a place where the photos are taken, and reflects the feeling of the user when taking the photos.

After a terminal or cloud obtains the voice information corresponding to the file, the terminal or cloud deciphers the voice information by using a speed recognition technology, extracts one or more keywords from the voice information, and sets the one or more keywords as tags of data. In the foregoing example, after the voice information “I am traveling in Paris now. How beautiful the scenery is!” is obtained, in cloud or the terminal, the voice information is quickly decomposed into four keywords “Paris”, “Traveling”, “Scenery” and “Beautiful”, and then the four keywords are set as the tags of the photo data of the user. Specifically, one of the four keywords, for example, “Paris” may be set as a primary tag, and the other three keywords are set as secondary tags.

In the file presentation method provided by the embodiment of the present invention, a speech recognition technology is used to extract keywords of voice information as tags of data, which makes a tag setting process very fast, user-friendly and intelligent, minimizes human inputs, and improves user experience in managing the data.

Alternatively, in step 101, the file information corresponding to the files may also be text information.

Accordingly, step 102 may be specifically as follows:

Extract keywords of the text information by using a text recognition technology, and set the keywords as tags of data.

The text information may correspond to a file in terms of content or other aspects. The process of extracting the keywords of the text information by using the text recognition technology is similar to the process of extracting the keywords of the voice information by using the speech recognition technology, which is not further described herein.

A text recognition technology is used to extract keywords of text information as tags of data, which makes a tag setting process very fast, user-friendly and intelligent, minimizes human inputs, and improves user experience in managing the data.

In another embodiment provided by the present invention, step 103 may be specifically as follows: presenting the files with a same tag according to a sequence of time at which the files are obtained.

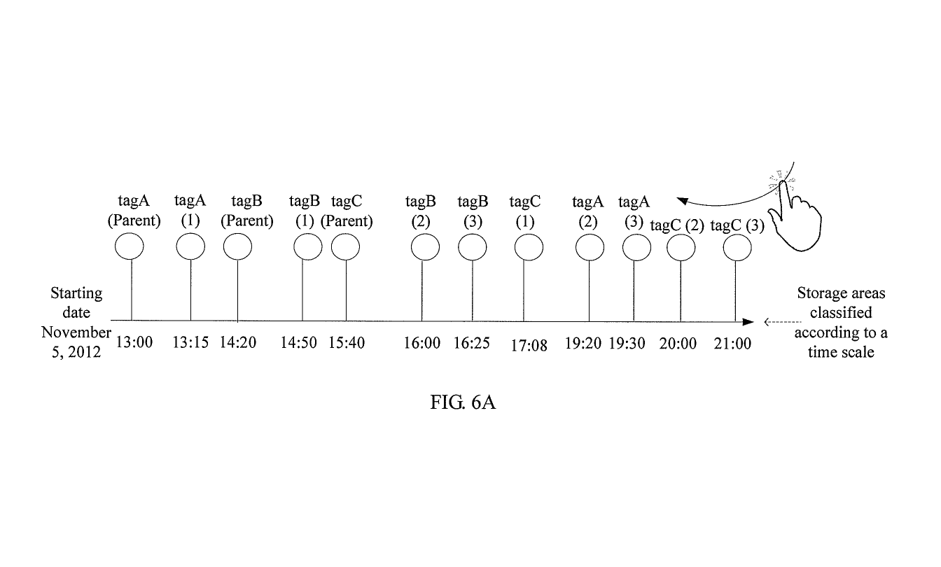

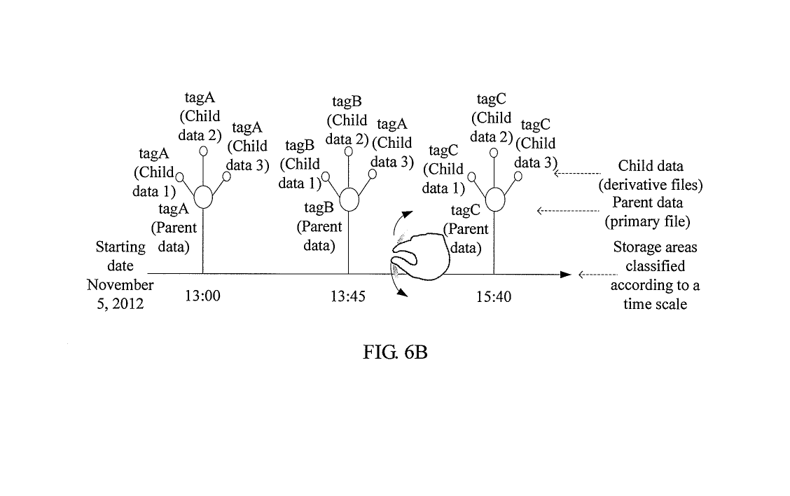

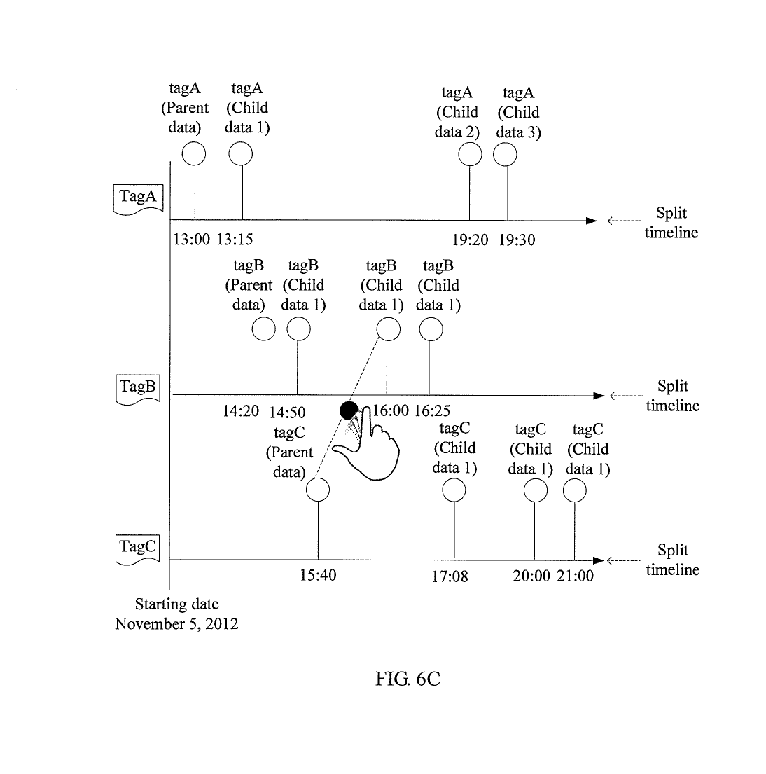

In this step, the files may be displayed in an interface by using a visual geometric figure. In addition, animation and sound maybe configured for the files to display the files and a relationship between the files in a livelier manner. As shown in FIG. 6C, each file is represented by a circle, and a timeline is represented by a vertical line, files with a same tag are presented on the timeline according to a sequence of time at which the files are obtained. On the left part of the timeline, a tag of each file is marked, and the time at which the file is obtained is marked on the timeline. In a series of files with tag (tag) A, a file obtained first may be referred to as parent data, and a file obtained second may be referred to as child data. In other embodiments of the present invention, the parent data may also be any one file with tagA and the child data may be nodes with tagA other than the parent node. Besides a split timeline named tagA, a split timeline named tagB also exists, on which all files with tagB are presented. The rest may be deduced in the same manner. In the user interface, timelines with different tags are presented from top to bottom. Assuredly, it is understood that FIG. 6C is only one alternative manner of this step and does not limit the scope of the present invention. Those skilled in the art can present, by using common knowledge or common means in this field, the files with a same tag according to a sequence of time at which the files are obtained. Files with a same tag are presented according to the sequence of time at which the files are obtained, which implements classified presentation of the files and helps the user view the files and perform subsequent operations and management.

In addition, step 103 may also be specifically as follows: presenting the files with a same tag in an aggregate form.

In this step, the files may be displayed in an interface by using a visual geometric figure. In addition, animation and sound may be configured for the files to display the files and a relationship between the files in a livelier manner. As shown in FIG. 6B, each file is represented by a circle, a timeline is represented by a virtual line, and files with a same tag are presented in an aggregate form. A circle with a larger area may be used to represent a file obtained first of the files with a same tag, where the file obtained first is referred to as parent data; circles with a smaller area are used to represent files obtained later of the files with a same tag, where the files obtained later are referred to as child data; the child data is connected to the parent data through a short line. On the timeline, only the time at which the parent data is obtained is displayed. In other embodiments of the present invention, the parent data may also be any one file with tagA and the child data may be nodes with tagA other than the parent node. It is understood that FIG. 6B is only one alternative manner of this step and does not limit the scope of the present invention. Those skilled in the art can present, by using common knowledge or common means in this field, the files with a same tag in an aggregate form. Files with a same tag are presented in an aggregate form, which visually presents a relationship between associated files so that the user can view each file clearly.

In addition to the foregoing two presentation manners, step 103 may also be specifically as follows: presenting the files according to a sequence of time at which the files are obtained.

As shown in FIG. 6A, all files are arranged on a same timeline according to the sequence of time at which the files are obtained, and the time at which each file is obtained is marked on the timeline.

The foregoing presentation manners in step 103 may be mutually switched according to user operations. The following describes in detail, with reference to FIG. 6A to FIG. 6C, how to switch between the three data presentation manners. Firstly, as shown in FIG. 6A, all data is presented in sequence along the timeline. Then, a gesture operation (for example, a finger slides to the left along the interface) of the user in the user interface is received, and data originally rooted on the timeline is rooted on the parent data. As shown in FIG. 6B, a distance between the parent data on the timeline is shortened, which implements combined presentation of the data and compression of the timeline. Then, the timeline may be further compressed according to a further gesture operation (for example, a finger flicks to the left along the interface) of the user in the user interface, and the data is presented in a combined manner. For example, parent data obtained on the same day is compressed at one time point on the timeline. Finally, a gesture operation (for example, two fingers stretch along the user interface) of the user in the user interface is received, and the original one timeline is split into multiple timelines. As shown in FIG. 6C, data with a same tag is displayed in each split timeline, which implements classified and associated presentation of the data.

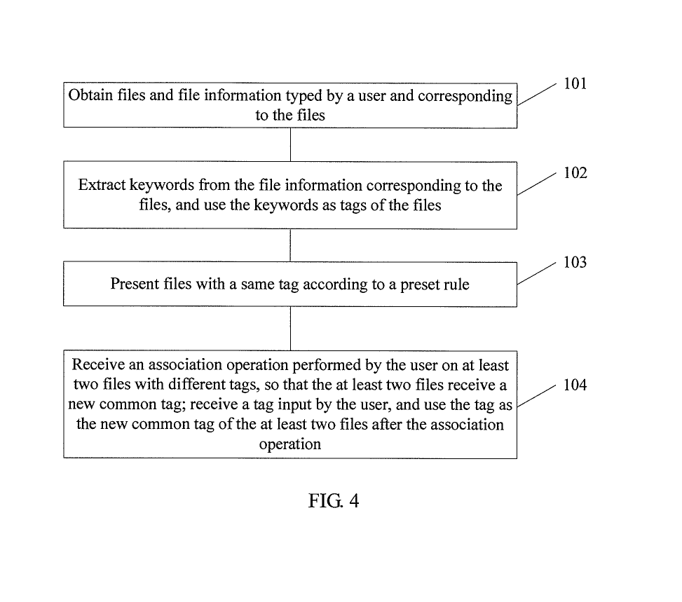

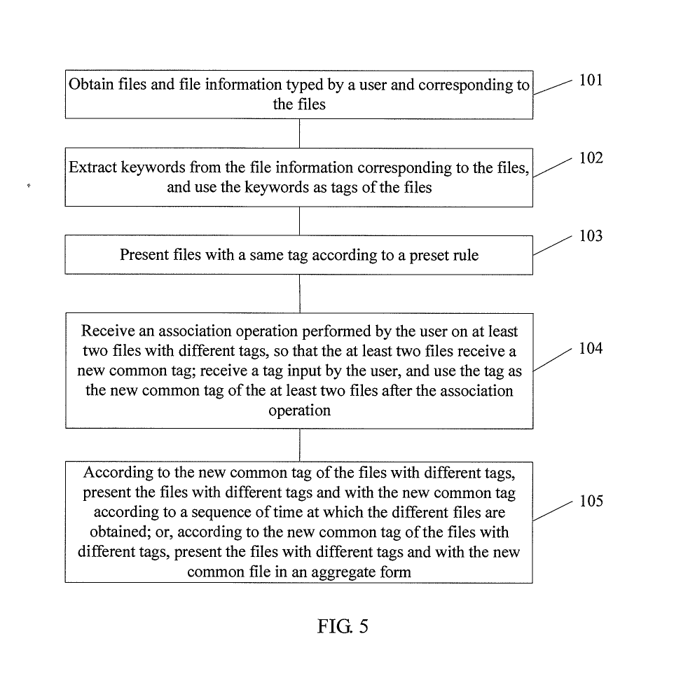

In another embodiment of the present invention, after step 103, as shown in FIG. 4, the method further includes step 104: receive an association operation performed by the user on at least two files with different tags, so that the at least two files receive a new common tag; receive a tag input by the user, and use the tag as the new common tag of the at least two files after the association operation.

After the files are presented, the user may further establish, according to a new understanding and a new idea of the data, an association between multiple pieces of data with different tags to help the user perform secondary management on the data. The user may perform an association operation on the files with different tags by using multiple manners. A preferred manner is as shown in FIG. 6C. A gesture operation (for example, a pinch operation is performed between two pieces of data along the user interface) of the user is received, and the original files with different tags are associated, so that these files with different tags can receive a new common tag, which helps the user establish an association between data according to personal willingness of the user in a process of viewing data subsequently.

Then, a tag input by the user is received, and the tag is used as the new common tag of the at least two files after the association operation. A new tag input by the user is received to set a same tag for the files with different tags after the association operation, which facilitates subsequent management and viewing on the data. As shown in FIG. 6C, an association is established between a file with tagE and a file with tagC, and then a new common tag is input for these two files, which facilitates new management and presentation on the two files.

Optionally, after step 104, the file presentation method provided by this embodiment may further include step 105:
according to the new common tag of the files with different tags, present the files with different tags and with the new common tag according to a sequence of time at which the different files are obtained; or
according to the new common tag of the files with different tags, present the files with different tags and with the new common tag in an aggregate form.

For details about the foregoing specific presentation manners with respect to different files, reference may be made to the specific descriptions of step 103, which is not further described herein. After the data is presented, a new tag input by the user is received, so that a new classified presentation can be performed on different events for which the user establishes tags subsequently.

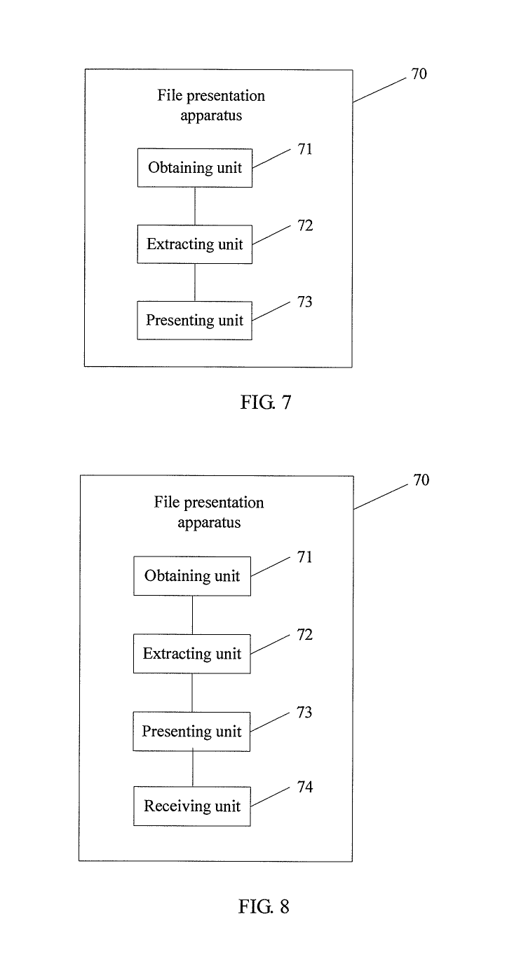

Corresponding to the foregoing method, an embodiment of the present invention also provides a file presentation apparatus. As shown in FIG. 7, the apparatus 70 includes:
an obtaining unit 71, configured to obtain files and file information typed by a user and corresponding to the files;
an extracting unit 72, configured to extract keywords from the file information corresponding to the files, and use the keywords as tags of the files; and
a presenting unit 73, configured to present files with a same tag according to a preset rule.

In the file presentation apparatus provided by the embodiment of the present invention, an extracting unit 72 extracts tags of files from file information corresponding to the files, a presenting unit 73 presents the files according to the tags, which helps a user perform classified management and viewing on the files by tag, thereby greatly improving user experience in managing and viewing data.

Alternatively, the file presentation apparatus is a cloud apparatus, and the obtaining unit is specifically configured to receive a data packet from a same user of one or more different terminals, where the data packet includes the files and the file information typed by the user and corresponding to the files;
the extracting unit is specifically configured to extract the keywords from the file information corresponding to the files, and use the keywords as the tags of the files; and
the presenting unit is specifically configured to present the files with a same tag according to the preset rule.

In the file presentation apparatus provided by the embodiment of the present invention, cloud receives a data packet of a same user from one or more different terminals, which helps the user perform unified management on data and addresses disadvantages of decentralized collection and decentralized management of data.

Alternatively, the file presentation apparatus is a terminal apparatus;
the obtaining unit is specifically configured to generate the files and the file information typed by the user and corresponding to the files;
the extracting unit is specifically configured to enable the terminal to extract the keywords from the file information corresponding to the files and use the keywords as the tags of the files; and
the presenting unit is specifically configured to present the files with a same tag according to the preset rule.

In the embodiment of the present invention, when the file information corresponding to the files is voice information:
the extracting unit 72 is specifically configured to extract keywords of the voice information by using a speech recognition technology, and set the keywords as tags of data.

When the file information corresponding to the files is text information:
the extracting unit 72 is specifically configured to extract keywords of the text information by using a text recognition technology, and set the keywords as tags of data.

In the file presentation apparatus provided by the embodiment of the present invention, a speech recognition technology or a text recognition technology is used to extract keywords of voice information or text information as tags of data, which makes a tag setting process very fast, user-friendly and intelligent, minimizes human inputs, and improves user experience in managing the data.

In an embodiment provided by the present invention, the presenting unit 73 is specifically configured to present the files with a same tag according to a sequence of time at which the files are obtained. Files with a same tag are presented according to a sequence of time at which the files are obtained, which implements classified presentation of files and helps a user view the files and perform subsequent operations and management.

In another embodiment provided by the present invention, the presenting unit 73 may be specifically configured to present the files with a same tag in an aggregate form. Files with a same tag are presented in an aggregate form, which visually presents a relationship between associated files so that the user can view each file clearly.

In another embodiment provided by the present invention, as shown in FIG. 8, the apparatus further includes a receiving unit 74, where after the presenting unit 73 presents the files with a same tag according to a sequence of time at which the files are obtained, the receiving unit 74 is configured to receive an association operation performed by the user on at least two files with different tags, so that the at least two files receive a new common tag; receive a tag input by the user, and use the tag as the new common tag of the at least two files after the association operation.

The present invention can help the user establish an association between data according to personal willingness of the user in a process of viewing the data subsequently, which facilitates viewing of related data and improves user experience in managing the data.

Alternatively, after the receiving unit 74 receives the tag input by the user and uses the tag as the new common tag of the at least two files after the association operation, the presenting unit 73 is further configured to: according to the new common tag of the files with different tags, present the files with different tags and with the new common tag according to a sequence of time at which the files with different tags are obtained; or the presenting unit 73 is further configured to: according to the new common tag of the files with different tags, present the different files with the same new common tag in an aggregate form. For details about the foregoing specific manners of presenting different files by the presenting unit 73, reference may be made to the specific descriptions of the foregoing embodiment, which is not further described herein. After the data is presented, a tag input by the user is received, so that a new classified presentation can be performed on different events for which the user establishes tags subsequently.

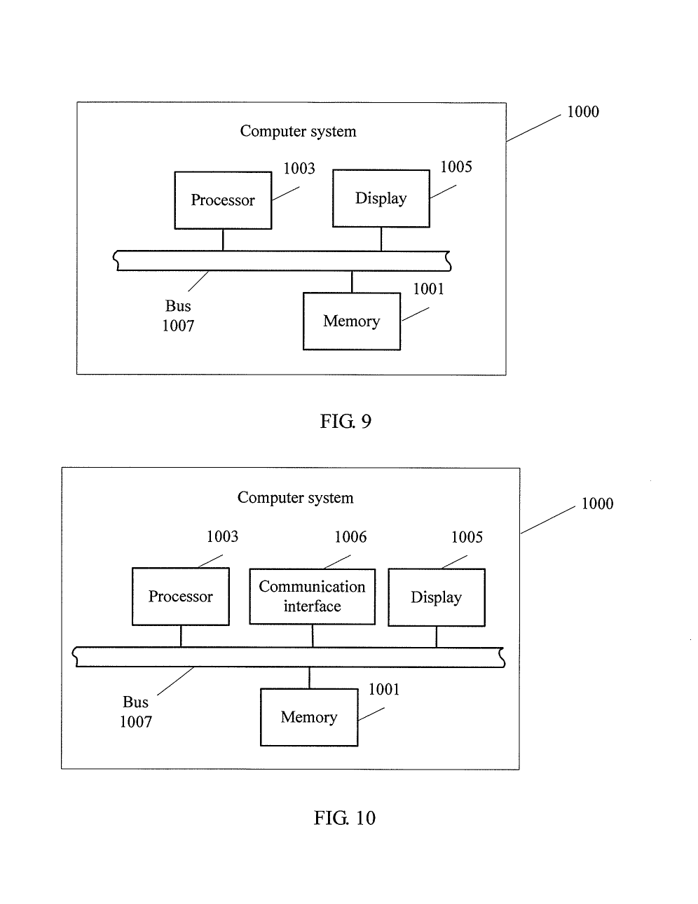

An embodiment of the present invention provides a computer system. As shown in FIG. 9, FIG. 9 is a schematic structural diagram of an embodiment of a computer system according to the present invention. The computer system 1000 includes a memory 1001, a processor 1003, a display 1005, and a bus 1007, where the memory 1001, the processor 1003, and the display 1005 are connected through the bus 1007. The memory 1001 is configured to store data and code, where the data includes files and file information typed by a user, and corresponding to the files; the processor 1003 is coupled with the memory 1001 and is configured to invoke the data and the code in the memory 1001 to implement the following functions: obtaining the files and the file information typed by the user and corresponding to the files from the memory 1001; extracting keywords from the file information corresponding to the files, and using the keywords as tags of the files; and controlling the display 1005 to present, according to a preset rule, files with a same tag.

In another embodiment of the present invention, the computer system 1000 is a cloud server. As shown in FIG. 10, the cloud server further includes a communication interface 1006, where the communication interface 1006 is connected to the memory 1001, the processor 1003, and the display 1005 through the bus 1007. The communication interface 1006 is configured to receive a data packet from a same user of one or more terminals, where the data packet includes files and file information typed by the user and corresponding to the files; the memory 1001 is configured to store data and code, where the data includes the files received from the communication interface 1006 and the file information typed by the user and corresponding to the files; the processor 1003 is coupled with the memory 1001 and is configured to invoke the data and the code in the memory 1001 to implement the following functions: obtaining the files from the memory 1001 and the file information typed by the user and corresponding to the files; extracting keywords from the file information corresponding to the files, and using the keywords as tags of the files; and controlling the display 1005 to present, according to a preset rule, files with a same tag.

In another embodiment of the present invention, the computer system 1000 is a terminal computer device.

A person of ordinary skill in the art may understand that, all or a part of the processes of the foregoing method embodiments may be implemented by a computer program instructing relevant hardware. The foregoing program may be stored in a computer readable storage medium. When the program runs, the steps of the foregoing method embodiments are performed. The foregoing storage medium may include any mediums capable of storing program code, such as a ROM, a RAM, a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A file presentation method, comprising:
obtaining files and file information typed by a user and corresponding to the files;
extracting keywords from the file information corresponding to the files, and using the keywords as tags of the files; and
presenting files with a same tag according to a preset rule.

2. The method according to claim 1, wherein:
obtaining files and file information typed by a user and corresponding to the files comprises: receiving, by a cloud, a data packet from a same user of one or more terminals, wherein the data packet comprises the files and the file information typed by the user and corresponding to the files;
extracting keywords from the file information corresponding to the files and using the keywords as tags of the files comprises: extracting, by cloud, the keywords from the file information corresponding to the files, and using the keywords as the tags of the files; and
presenting files with a same tag according to a preset rule comprises: presenting, by cloud, the files with a same tag according to the preset rule.

3. The method according to claim 1, wherein: obtaining files and file information typed by a user and corresponding to the files comprises: generating, by a terminal, the files and the file information typed by the user and corresponding to the files;
extracting keywords from the file information corresponding to the files and using the keywords as tags of the files comprises: extracting, by the terminal, the keywords from the file information corresponding to the files, and using the keywords as the tags of the files; and
presenting files with a same tag according to a preset rule comprises: presenting, by the terminal, the files with a same tag according to the preset rule.

4. The method according to claim 1, wherein the file information corresponding to the files is voice information; and
extracting keywords from the file information corresponding to the files and using the keywords as tags of the files comprises:
extracting keywords of the voice information by using a speech recognition technology, and setting the keywords as tags of data.

5. The method according to claim 1, wherein the file information corresponding to the files is text information; and
extracting keywords from the file information corresponding to the files and using the keywords as tags of the files comprises: extracting keywords of the text information by using a text recognition technology, and setting the keyword as tags of the data.

6. The method according to claim 1, wherein presenting files with a same tag according to a preset rule comprises: presenting the files with a same tag according to a sequence of time at which the files are obtained.

7. The method according to claim 1, wherein presenting files with a same tag according to a preset rule comprises: presenting the files with a same tag in an aggregate form.

8. The method according to claim 6, wherein after presenting files with a same tag according to a sequence of time at which the files are obtained, the method further comprises: receiving an association operation performed by a user on at least two files with different tags, so that the at least two files receive a new common tag;
receiving a tag input by the user, and using the tag as the new common tag of the at least two files after the association operation.

9. The method according to claim 8, wherein after receiving a tag input by the user and using the tag as the new common tag of the at least two files after the association operation, the method further comprises:
according to the new common tag of the files with different tags, presenting the files with different tags and with the new common tag according to a sequence of time at which the files with different tags are obtained; or
according to the new common tag of the files with different tags, presenting the files with different tags and with the new common tag in an aggregate form.

10. A file presentation apparatus, comprising:
an obtaining unit, configured to obtain files and file information typed by a user and corresponding to the files;
an extracting unit, configured to extract keywords from the file information corresponding to the files, and use the keywords as tags of the files; and
a presenting unit, configured to present files with a same tag according to a preset rule.

11. The apparatus according to claim 10, wherein:
the file presentation apparatus is a cloud apparatus;
the obtaining unit is configured to receive a data packet from a same user of one or more terminals, wherein the data packet comprises the files and the file information typed by the user and corresponding to the files;
the extracting unit is configured to extract the keywords from the file information corresponding to the files, and use the keywords as the tags of the files; and
the presenting unit is configured to present the files with a same tag according to the preset rule.

12. The apparatus according to claim 10, wherein:
the file presentation apparatus is a terminal apparatus;
the obtaining unit is configured to generate the files and the file information typed by the user and corresponding to the files;
the extracting unit is configured to enable the terminal to extract the keywords from the file information corresponding to the files and use the keywords as the tags of the files; and
the presenting unit is configured to present the files with a same tag according to the preset rule.

13. The apparatus according to claim 10, wherein:
the file information corresponding to the files is voice information; and
the extracting unit is configured to extract keywords of the voice information by using a speech recognition technology, and set the keyword as tags of the data.

14. The apparatus according to claim 10, wherein:
the file information corresponding to the files is text information; and
the extracting unit is configured to extract keywords of the text information by using a text recognition technology, and set the keywords as tags of the data.

15. The apparatus according to claim 10, wherein presenting unit is configured to present the files with a same tag according to a sequence of time at which the files are obtained.

16. The apparatus according to claim 10, wherein presenting unit is configured to present the files with a same tag in an aggregate form.

17. The apparatus according to claim 15, further comprising a receiving unit, wherein after the presenting unit presents the files with a same tag according to a sequence of time at which the files are obtained, the receiving unit is configured to receive an association operation performed by a user on at least two files with different tags, so that the at least two files receive a new common tag, receive a tag input by the user, and use the tag as the new common tag of the at least two files after the association operation.

18. The apparatus according to claim 17, wherein after the receiving unit receives a tag input by the user and uses the tag as the new common tag of the at least two files after the association operation, the presenting unit is further configured to: according to the new common tag of the files with different tags, present the files with different tags and with the new common tag according to a sequence of time at which the files with different tags are obtained; or the presenting unit is further configured to: according to the new common tag of the files with different tags, present the different files with the same new common tag in an aggregate form.
